(19) United States
(12) Patent Application Publication
(10) Pub. No.: US 2020/0218772 A1
(43) Pub. Date: Jul. 9, 2020

(54) METHOD AND APPARATUS FOR DYNAMICALLY IDENTIFYING A USER OF AN ACCOUNT FOR POSTING IMAGES

(71) Applicant: NEC CORPORATION, Tokyo (JP)

(72) Inventors: Wen ZHANG, Singapore (SG); Masahiro TANI, Singapore (SG)

(73) Assignee: NEC CORPORATION, Tokyo (JP)

(21) Appl. No.: 16/630,094

(22) PCT Filed: Jun. 28, 2018
(86) PCT No.: PCT/JP2018/024587

§ 371 Date: Jan. 10, 2020

(30) Foreign Application Priority Data
Jul. 19, 2017 (SG) 10201705921V

(51) Int. Cl. G06F 16/9535; G06K 9/00; G06F 21/31

(52) U.S. Cl. CPC G06F 16/9535; G06K 2009/00583; G06F 21/316; G06K 9/00577

(57) ABSTRACT

According to the first aspect, there is provided a method, by a server, for dynamically identifying a user of an account for posting images, comprising: determining, by the server, if images posted in the account of the user includes an image capturing device; extracting, by the server, a characteristic of the image of the image capturing device when it is determined that the images in the account includes the image capturing device; and identifying, by the server, an image capturing device of the user in response to the extraction of the characteristic of the image of the image capturing device.

### TECHNICAL FIELD

The present invention relates broadly, but not exclusively, to methods and apparatuses for dynamically identifying a user of an account for posting images.

### BACKGROUND ART

With the rapid development of technology, it is extremely easy for a user to create or access a social account from virtually any location in the world at any time of the day. As such, a user typically has multiple accounts in cyberspace, for example, in various forums, social media networks such as Facebook, Twitter and Instagram.

However, the anonymity and ease in setting up an account pose many challenges for detecting fraudulent activity. This includes detecting fraudulent accounts that are created by individuals who are not whom they claim to be.

Currently, conventional techniques to detect fraudulent accounts include comparing information of the subject user on one account (e.g., Facebook) to that on another different account belonging to the same subject user.

FIG. 1A shows a block diagram of a conventional system 100 utilising one such conventional technique which performs camera source identification in order to identify a user. The convention system 100 includes a module 106, which is configured to identify a camera source by comparing images that are posted in one account 102 and images that are posted in another account 104. The conventional technique includes extracting a corresponding fingerprint from images that are posted in each account 102, 104 and link them to the devices that acquired them (for example, image capturing devices that are used to capture these images). An output 108 will be generated, indicating if the two users are matched. That is, the two users are matched if the images are identified as being taken by same device.

PRNU (Photo-Response Non-Uniformity) is a common and robust fingerprint that is being widely used. However, this technique does not generate reliable results; at times, the results may even be misleading when the images suffer from severe distortions which affect the identification result or when different users share images in cyberspace.

FIG. 1B shows a block diagram of a conventional system 150 utilising another conventional technique which performs face identification in order to identify a user. The convention system 150 includes a module 156, which is configured to identify a face by comparing images that are posted in one account 152 and images that are posted in another account 154. The conventional technique includes extracting an image of a face from images that are posted in each account 152, 154 and link them to the corresponding users. An output 158 will be generated, indicating if the two users are matched. That is, the two users are matched if the images of the faces are identified as being similar or identical. However, the results are typically not convincing when the images of the face posted on a social media account are not genuine or hidden.

A need therefore exists to provide methods for dynamically identifying a user of an account for posting images that address one or more of the above problems.

Furthermore, other desirable features and characteristics will become apparent from the subsequent detailed description and the appended claims, taken in conjunction with the accompanying drawings and this background of the disclosure.

### SUMMARY OF INVENTION

### Solution to Problem

According to the first aspect, there is provided a method, by a server, for dynamically identifying a user of an account for posting images, comprising: determining, by the server, if images posted in the account of the user includes an image capturing device; extracting, by the server, a characteristic of the image of the image capturing device when it is determined that the images in the account includes the image capturing device; and identifying, by the server, an image capturing device of the user in response to the extraction of the characteristic of the image of the image capturing device.

According to a second aspect, there is an apparatus for dynamically identifying a user of an account for posting images r, the apparatus comprising: at least one server; and

at least one memory including computer program code; the at least one memory and the computer program code configured to, with at least one processor, cause the apparatus at least to: determine if images posted in the account of the user includes an image capturing device;

extract a characteristic of the image of the image capturing device when it is determined that the images in the account includes the image capturing device; and

identify an image capturing device of the user in response to the extraction of the characteristic of the image of the image capturing device.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1A show block diagrams of a conventional system within which efficiency of a transport provider is optimized.

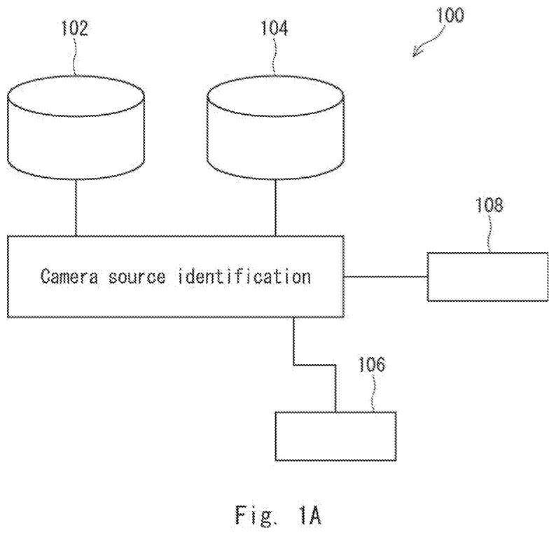

FIG. 1B show block diagrams of a conventional system within which efficiency of a transport provider is optimized.

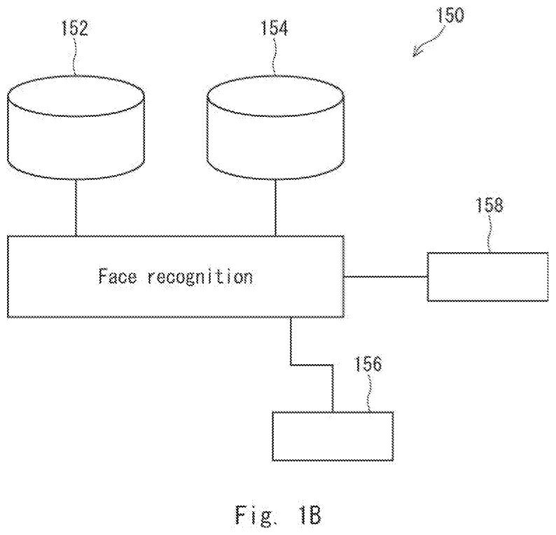

FIG. 2 shows a block diagram of a system within which a user of an account for posting images is dynamically identified according to an embodiment.

FIG. 3 shows a flowchart illustrating a method for dynamically identifying a user of an account for posting images in accordance with embodiments of the invention.

FIG. 4 shows a block diagram of a system within which a user of an account for posting images is dynamically identified in accordance with embodiments of the invention.

FIG. 5 shows an example as to how efficiency of an image capturing device of the user may be identified in accordance with embodiments of the present inventions.

FIG. 6 shows an exemplary computing device that may be used to execute the method of FIG. 3.

### DESCRIPTION OF EMBODIMENTS

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”. “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments of the present invention relate to methods and apparatuses for dynamically identifying a user of an account of posting images. In an embodiment, the method and apparatus dynamically identifies a user in response to identifying the image capturing device of the user.

In the following description, a user may refer to one who uses an account for posting at least images, text and multi-media data. In specific embodiments, the user of the account may be registered as a user of at least one more account. For example, the user may register for an account on Facebook and another account on Instagram. Alternatively, the user may register for more than one account on Facebook. A target user may refer to one who is registered for a different account than that being used by the user. In various embodiments, the target user is the user. In various embodiments, the account is a social account. In other words, images that are posted in an account include those that are posted and shown under the account registered under the user.

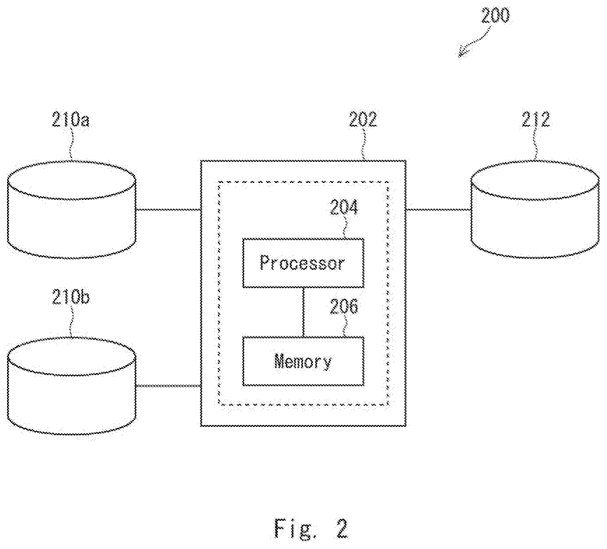

FIG. 2 shows a block diagram of a system within which a user of an account for posting images is dynamically identified according to an embodiment.

Referring to FIG. 2, provision of the dynamic identification process involves an apparatus 202 that is operationally coupled to at least one database 210a associated to an account for posting images. The database 210a may store data corresponding to an account (or account data). Examples of the account data include name, age group, income group, address, gender or the like relating to the user. Also, the at least one database 210a includes information that have been posted by the user on an account. The posted information includes, among other things, images, text and multi-media files. Further, data (e.g., time and date) relating to the posted information are included in the database 210a.

In other embodiments, the apparatus 202 may also be configured to communicate with, or may include, another database 210b. The database 210b may include data relating to an account belong to a target user. Similar to the database 210a, the database 210b may store data corresponding to that account belonging to the target user and information that have been posted by the target user on the account.

Similarly, in other embodiments, the apparatus 202 may also be configured to communicate or may include another database 212 which may include a plurality of characteristics for each of a plurality of image capturing devices that are available. The database 212 may be updated by more than a party. For example, a corresponding supplier or manufacturer may be able to update the database 212 when there is a new model or a new image capturing device.

The apparatus 202 is capable of wireless communication using a suitable protocol. For example, embodiments may be implemented using databases 210a, 210b, 212 (e.g., cloud database) that are capable of communicating with Wi-Fi/Bluetooth-enabled apparatus 202. It will be appreciated by a person skilled in the art that depending on the wireless communication protocol used, appropriate handshaking procedures may need to be carried out to establish communication between the databases 210a, 210b and the apparatus 202. For example, in the case of Bluetooth communication, discovery and pairing of the databases 210a, 210b and the apparatus 202 may be carried out to establish communication.

The apparatus 202 may include a processor 204 and a memory 206. In embodiments of the invention, the memory 206 and the computer program code, with processor 204, are configured to cause the apparatus 202 to determine if images posted in the account of the user includes an image capturing device: extract a characteristic of the image of the image capturing device when it is determined that the images in the account includes the image capturing device; and identify an image capturing device of the user in response to the extraction of the characteristic of the image of the image capturing device.

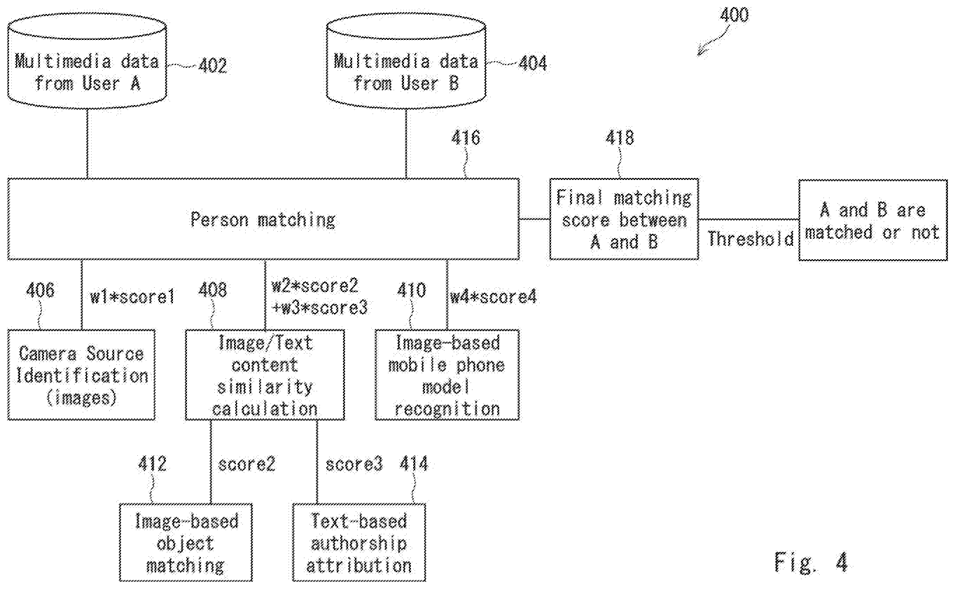

The apparatus 202 may be a server (e.g. a user matching server 416 in FIG. 4 below). In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

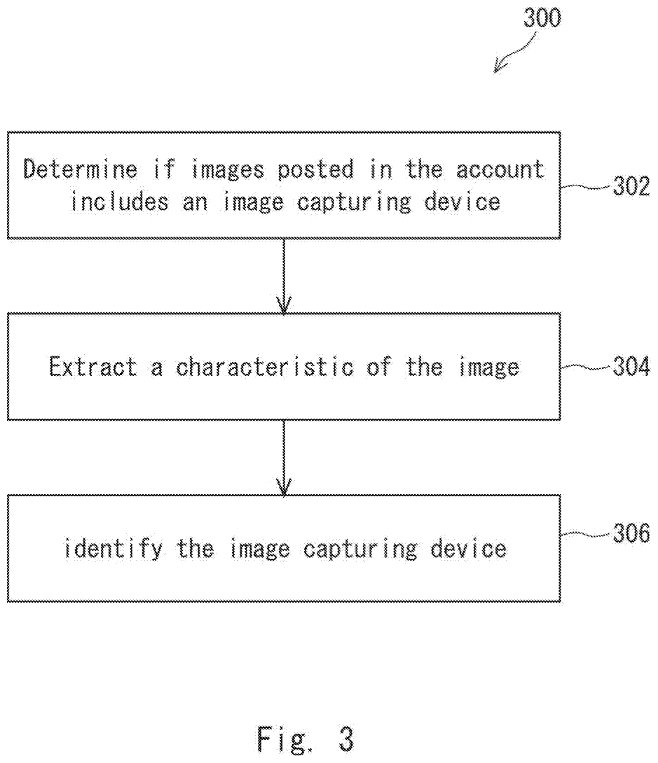

Such a server may be used to implement the method 300 shown in FIG. 3. FIG. 3 shows a flowchart illustrating a method 300 for dynamically identifying a user of an account for posting images in accordance with embodiments of the invention.

With the rapid development of technology, it is extremely easy for a user to create or access a social account from virtually any location in the world at any time of the day. As such, a user typically has multiple accounts in cyberspace, for example, in various forums, social media networks such as Facebook, Twitter and Instagram. However, the anonymity and ease in setting up an account pose many challenges for detecting fraudulent activity. As mentioned in the above, the conventional techniques are unreliable and often misleading.

Advantageously, embodiments of the present invention can advantageously dynamically identify a user by identifying the image capturing device (e.g., mobile phone, camera and tablets) of the user. This is made possible because various embodiments identify the image capturing device by extracting a characteristic of an image of the image capturing device and identifying it based on the information stored in a database (e.g. database 212). In accordance with various embodiments, an image capturing device of the user is identified so as to identify a user, for example, based on an image capturing device that is used to take a profile picture used to register for an account. Further, other techniques like determining one of image-based image capturing device recognition, image-based content similarity and text-based content similarity can assist image capturing device identification, thereby providing results of higher accuracy and reliability.

The method 300 broadly includes:

step 302: determining, by a server, if images posted in an account of the user includes an image capturing device

step 304: extracting, by the server, a characteristic of the image of the image capturing device when it is determined that the images in the account includes the image capturing device.

step 306: identifying, by the server, an image capturing device of the user in response to the extraction of the characteristic of the image of the image capturing device.

At step 302, the server 202 accesses a database 210a to analyse through the images that have been posted in the account of a user (e.g., user A) so as to determine if the images include an image capturing device. The image capturing device is one that is used to take an image that has been posted and is seen in the posted image. In an example, the image capturing device is one that is used to take a selfie of the user in front of a mirror. As such, the image that has been taken by the image capturing device includes an image of the image capturing device. In other embodiments, the server 202 continues to access the database 210a to detect for other characteristics that may identify the user (e.g., fingerprints of an image) of it is determined that the images, that have been posted, does not include an image capturing device.

At step 304, the server 202 extracts a characteristic of the image of the image capturing device when it is determined that the images in the account include an image of the image capturing device. Examples of the characteristic include, among other things, a feature, a colour, a texture or any other information relating to the image capturing device that is registered and stored in database 212.

At step 306, the server 202 accesses a database (e.g., database 212) to compare the extracted characteristic of the image and each of the corresponding characteristics of image capturing devices. The database stores the corresponding characteristics of available image capturing devices. For example, the database may be updated with the corresponding characteristics whenever there is a new model or a new image capturing device. The image capturing device of the user may then be identified in response to the comparison. That is, the image capturing device of the user is one which has a matching characteristic to that of an image capturing device stored in the database.

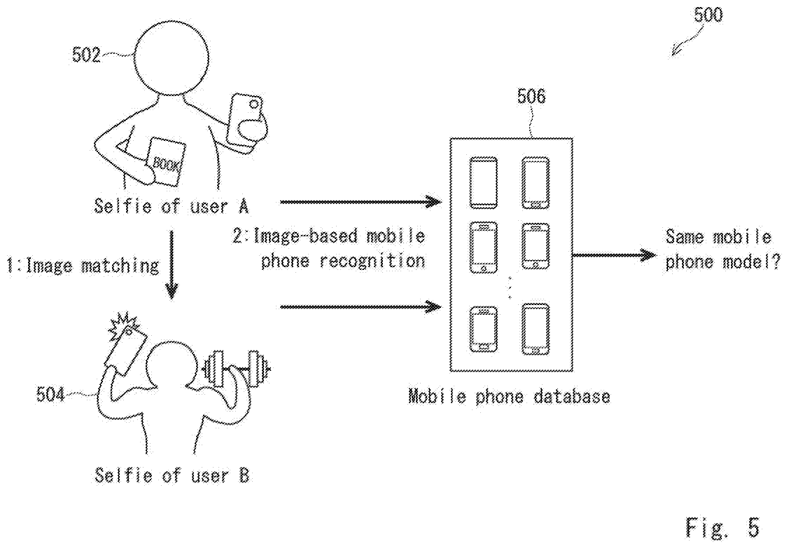

Subsequently, the method comprises a step of comparing the identified image capturing device of the user and an image capturing device of a target user (e.g., user B). The image capturing device of the target user may be identified by performing steps 302 to 306. Alternatively, the image capturing device of the user may be inputted to the server. More information in relation to this step is shown below in FIG. 5.

The method then determines a matching score in response to the comparison of the identified image capturing device of the user and the image capturing device of the target user. The matching score is one that indicates a degree of how much each of the two parameters that are being compared matches to the other. That is, the more similar the image capturing device of the user is to the image capturing device of the target user, the higher the matching score.

Alternatively or additionally, the method comprises a step of extracting a characteristic of the images posted in the account of the user to determine a fingerprint of the image capturing device of the user. Images are typically overlaid by a noise-like pattern of pixel-to-pixel non-uniformity. Like actual fingerprints, the digital noise-like patterns in original images is stochastic in nature. That is, it contains random variables which are usually created during the manufacturing process of the image capturing device (or a camera) and its sensors. This virtually ensures that the noise imposed on the digital images from any particular camera will be consistent from one image to the next, even while it is distinctly different. In other words, by determining a fingerprint of an image capturing device makes it possible to identify the image capturing device.

Additionally, the method comprises a step of comparing the determined fingerprint of the image capturing device and a fingerprint of the image capturing device of the target user. The image capturing device of the target user (e.g., user B) may be identified by performing the steps that have been done for the user (e.g., user A). Alternatively, the image capturing device of the user may be inputted to the server. The method then determines a matching score in response to the comparison of the determined fingerprint of the image capturing device and a fingerprint of the image capturing device of the target user. That is, the more similar the fingerprint of the image capturing device of the user is to that of the target user, the higher the matching score.

Additionally or alternatively, the method comprises a step of determining a content of the images posted in the account of the user. In order to determine the content of the image posted in the account, the server 202 accesses a database which is used to store the image that have been posted in the account of the user. The method may comprise a step of comparing the content of the images posted in the account of the user to a content of the images posted in an account of the target user. The text of the target user (e.g., user B) may be identified by performing the steps that have been done for the user (e.g., user A). The method then determine a matching score further in response to the comparison of the content of the images posted in the account of the user to a content of the images posted in the account of the target user. That is, the more similar the content of the images posted in the account of the user are to that of the target user, the higher the matching score.

Additionally or alternatively, the method comprises a step of processing the text that has been posted in the account of the user. In order to determine the content of the text that has been posted in the account, the server 202 accesses a database which is used to store the text that has been posted in the account of the user? The method may comprise a step of comparing the content of the text posted in the account of the user to a content of the text posted in an account of the target user. The images of the target user (e.g., user B) may be identified by performing the steps that have been done for the user (e.g., user A). The method then determine a matching score further in response to the comparison of the content of the text posted in the account of the user to a content of the text posted in the account of the target user. That is, the more similar the content of the text posted in the account of the user are to that of the target user, the higher the matching score.

In an example, the method comprises determining a corresponding weight (indicative of an importance of a result) to each of the (i) the comparison of the identified image capturing device of the user and the image capturing device of the target user, (ii) the comparison of the determined fingerprint of the image capturing device and the fingerprint of the image capturing device of the target user, (iii) the comparison of the content of the images posted in the account of the user to the content of the images posted in the account of the target user and (iv) the comparison of the content of the text posted in the account of the user to the content of the text posted in the account of the target user. Additionally or alternatively, the method comprises determining a corresponding weight one or more of the (i) the comparison of the identified image capturing device of the user and the image capturing device of the target user. (ii) the comparison of determined fingerprint of the image capturing device and the fingerprint of the image capturing device of the target user. (iii) the comparison of the content of the images posted in the account of the user to a content of the images posted in the account of the target user and (iv) the comparison of the content of the text posted in the account of the user to the content of the text posted in the account of the target user. In other words, a matching score (or a final matching score) may or may not be based on each of the comparison results of (i) to (iv) stated above. The final matching score may be one that depends on more than one comparison result.

The method may comprise a step of determining a likelihood if the user is the target user in response to the determined matching score. For example, the method may include determining if the matching score is above a threshold value (for example, 0.85). If it is determined that the matching score is above the threshold value, there is a high likelihood that the user is the target user.

FIG. 4 shows a block diagram of a system within which a user of an account for posting images is dynamically identified in accordance with embodiments of the invention. The system includes a user matching server 416 which is operationally coupled to a camera source (or an image capturing device) identification module 406, a image/text content similarity calculation module 408 and an image-based mobile phone model recognition module 410 for dynamically identifying a user of an account.

The user matching server 416 typically is associated with a party who is dynamically identifying a user. A party may be an entity (e.g. a company or organization) which administers (e.g. manages) an account (e.g. Facebook) for posting images. As stated in the above, the user matching server 416 may include one or more computing devices that are used to establish communication with another server by exchanging messages with and/or passing information to another device (e.g. a database).

The user matching server 416 may be configured to retrieve information from the databases 402 and 404. Each of the databases 402 and 404 is configured to store multimedia data (e.g., images) that has been posted by a user (e.g., user A) and a target user (e.g., user B), respectively. The user matching server 416 may be operationally coupled to the camera source identification module 406, the image/text content similarity calculation module 408 and the image-based mobile phone model recognition module 410. That is, the user matching server 416 is configured to receive information (e.g., a weighed matching score) from the camera source identification module 406, the image/text content similarity calculation module 408 and the image-based mobile phone model recognition module 410 for generating an output that is input into an matching module 418 for dynamically identifying a user of an account.

At the matching module 418, the output (e.g., a final matching score) from the user matching server 416 will be processed to determine if it is above a threshold value. In response to determining if the final matching score is above a threshold value, the matching module 418 generates an output indicative of a likelihood if the user (e.g., user A) is the target user (e.g., user B).

More information on the above components may be found below:

Databases 402, 404: These are configured to store multimedia data from users A and B which are images and text-based data extracted from the corresponding user accounts belonging to users A and B from cyberspace, such as from social media networks and forums using automatic data collection module. The images include the user's profile images, cover photos or any other publicly available image-based posts. The text-based posts of one user can be a concatenation of each piece of publicly available texts on his social media page, which can be very casual sentences, such as “Stood in the queue for two hours, but it is totally worth it”. In various embodiments, the account belonging to user B is one that is being matched against a query account (e.g., one belonging to user A).

User matching server 416: This is configured to match the respective matching score of user A and user B using three data analytics modules, including the camera source identification module 406, the image/text content similarity calculation module 408 and the image-based mobile phone model recognition module 410. The image/text content similarity calculation module 408 includes an image-based object matching module 412 and a text-based authorship attribution module 414. Each of the modules will give a matching score of the similarity between the two users and the final matching score is a weighted sum. A threshold will be set to determine if user A is user B which also indicates if the accounts belonging to user A and user B are created by the same person.

Camera source identification module 406: This is configured to determine a fingerprint of images that have been posted in an account to determine an image capturing device (or a camera) that has been used. The determined fingerprint is able to distinguish cameras of the same model and brand. These fingerprints come from different parts or processing stages of the digital camera including camera lens distortions, sensor dust pattern. Photo-Response Non-Uniformity (PRNU) and etc. This module forms par of the user identification solution to associate different users in cyber space and generates a matching score based on a comparison of the fingerprint determined for each of the accounts.

Image/text content similarity calculation module 408: This is configured to determine user matching based on image and text content from two users. It may include an image-based object recognition module 412 and a text-based authorship attribution module 412, the matching score that is outputted from the image/text content similarity calculation module may be a combination of scores from the two modules. Advantageously, the image/text content similarity calculation module 408 is used to increase the accuracy of the user matching server 416.

Image-based object recognition module 410: This is configured to match objects in images using computer vision technology. The objects can be tattoos, backgrounds of the photo or any other generic objects in which the features can be extracted and matched. The local features, which represent the local characteristics based on the particular salient patches or interest points are used in matching technology due to the robustness to a wide range of variations. The local features can be further categorized as corner based features, blob based features and region based features, addressing different situations. This module helps to increase the accuracy of the user matching server 416 because nowadays people tend to post a lot of images online and there are high chances that two users correspond to the same person if their photos contain a common object.

Text-based authorship attribution module 412: This is configured to link the authors of texts from different users with writing style. The features capturing the writing style of authors are extracted from training and query documents first then the query document is classified into one of the authors in training set using machine learning technologies. For the purposes of identifying the user, user A's text-based posts are combined as the query document to be matched against the training set in which user B's posts is the positive training data. A matching score is the obtained indicating the writing-style based similarity between user A and user B.

Image-based mobile phone model recognition module 410: This is configured to match mobile phone models (or image capturing device models) in selfie images from two users shot in front of a mirror with the photographer holding the phone. Recently many people take this type of selfies and post online in order to include the whole body or the whole background. It is probable that the two users are the same person when they use the same mobile phone model. More information may be found in FIG. 5.

Matching module 418: This is configured to determine a weighted score of the respective score from each of the camera source identification module 406, the image/text content similarity calculation module 408 and the image-based mobile phone model recognition module 410. In various embodiments, the camera source identification 406 and mobile phone model recognition 410 are not completely independent, both are configured to link image acquisition devices between two users and help to verify each other, the probability of two users being the same should be doubled when high matching score is obtained from both two methods. Therefore a threshold is set on the two matching scores and both are doubled or multiplied by a parameter over 1 when they exceed the threshold.

FIG. 5 shows an example as to how an image capturing device of the user may be identified in accordance with embodiments of the present inventions.

As shown in FIG. 5, one way to achieve it is to match selfies from user A, 502, and B, 504, directly using an image-based object matching module 410 and a matching score is obtained. The other way is to match the mobile phone models in the selfies against a large mobile phone model database 506 separately then decide whether the models correspond to each other. In various embodiments, the method works when a phone case is attached to the back side of the mobile phone, since the camera lens is still visible to extract unique features of the mobile phone model for matching. As such, it is possible to recognize and match the mobile phone models based on the position of the camera lens.

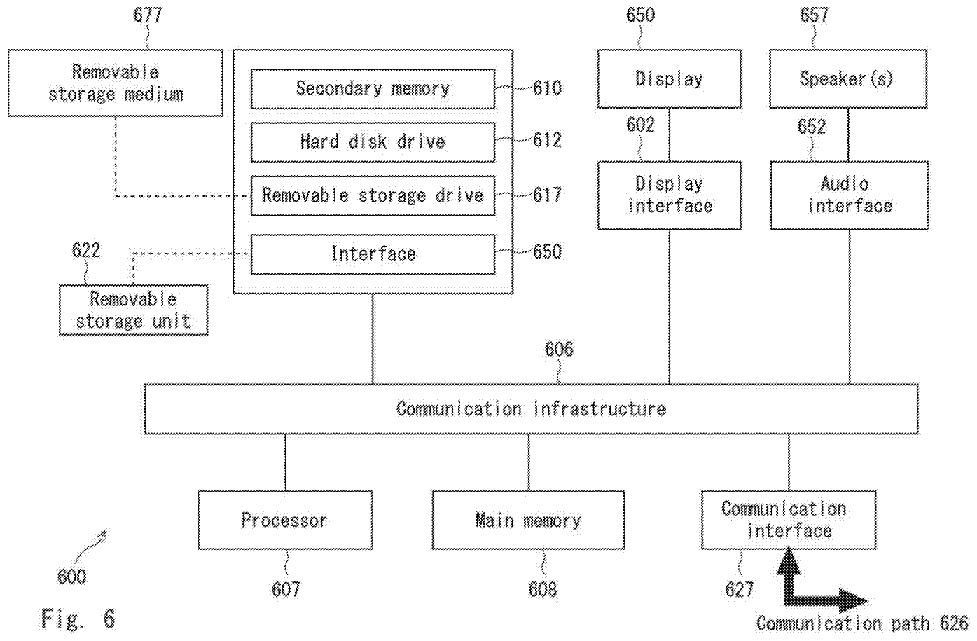

FIG. 6 depicts an exemplary computing device 600, hereinafter interchangeably referred to as a computer system 600, where one or more such computing devices 600 may be used to execute the method of FIG. 3. The exemplary computing device 600 can be used to implement the system 200, 400 shown in FIGS. 2 and 4. The following description of the computing device 600 is provided by way of example only and is not intended to be limiting.

As shown in FIG. 6, the example computing device 600 includes a processor 607 for executing software routines. Although a single processor is shown for the sake of clarity, the computing device 600 may also include a multi-processor system. The processor 607 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a storage drive 612, which may be a hard disk drive, a solid state drive or a hybrid drive and/or a removable storage drive 617, which may include a magnetic tape drive, an optical disk drive, a solid state storage drive (such as a USB flash drive, a flash memory device, a solid state drive or a memory card), or the like, The removable storage drive 617 reads from and/or writes to a removable storage medium 677 in a well-known manner. The removable storage medium 677 may include magnetic tape, optical disk, non-volatile memory storage medium, or the like, which is read by and written to by removable storage drive 617. As will be appreciated by persons skilled in the relevant art(s), the removable storage medium 677 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 650. Examples of a removable storage unit 622 and interface 650 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 622 and interfaces 650 which allow software and data to be transferred from the removable storage unit 622 to the computer system 600.

The computing device 600 also includes at least one communication interface 627. The communication interface 627 allows software and data to be transferred between computing device 600 and external devices via a communication path 627. In various embodiments of the inventions, the communication interface 627 permits data to be transferred between the computing device 600 and a data communication network, such as a public data or private data communication network. The communication interface 627 may be used to exchange data between different computing devices 600 which such computing devices 600 form part an interconnected computer network. Examples of a communication interface 627 can include a modem, a network interface (such as an Ethernet card), a communication port (such as a serial, parallel, printer, GPIB, IEEE 1394. RJ45. USB), an antenna with associated circuitry and the like. The communication interface 627 may be wired or may be wireless. Software and data transferred via the communication interface 627 are in the form of signals which can be electronic, electromagnetic, optical or other signals capable of being received by communication interface 627. These signals are provided to the communication interface via the communication path 627.

As shown in FIG. 6, the computing device 600 further includes a display interface 602 which performs operations for rendering images to an associated display 650 and an audio interface 652 for performing operations for playing audio content via associated speaker(s) 657.

As used herein, the term “computer program product” may refer, in part, to removable storage medium 677, removable storage unit 622, a hard disk installed in storage drive 612, or a carrier wave carrying software over communication path 627 (wireless link or cable) to communication interface 627. Computer readable storage media refers to any non-transitory, non-volatile tangible storage medium that provides recorded instructions and/or data to the computing device 600 for execution and/or processing. Examples of such storage media include magnetic tape. CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 627. Such computer programs, when executed, enable the computing device 600 to perform one or more features of embodiments discussed herein. In various embodiments, the computer programs, when executed, enable the processor 607 to perform features of the above-described embodiments. Accordingly, such computer programs represent controllers of the computer system 600.

Software may be stored in a computer program product and loaded into the computing device 600 using the removable storage drive 617, the storage drive 612, or the interface 650. The computer program product may be a non-transitory computer readable medium. Alternatively, the computer program product may be downloaded to the computer system 600 over the communications path 627. The software, when executed by the processor 607, causes the computing device 600 to perform the necessary operations to execute the method 300 as shown in FIG. 3.

It is to be understood that the embodiment of FIG. 6 is presented merely by way of example to explain the operation and structure of the system 200 or 400. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

It will be appreciated that the elements illustrated in FIG. 6 function to provide means for performing the various functions and operations of the servers as described in the above embodiments.

When the computing device 600 is configured for dynamically identifying a user of an account for posting images, the computing system 600 will have a non-transitory computer readable medium having stored thereon an application which when executed causes the computing system 600 to perform steps comprising: determine if images posted in the account of the user includes an image capturing device; extract a characteristic of the image of the image capturing device when it is determined that the images in the account includes the image capturing device; and identify an image capturing device of the user in response to the extraction of the characteristic of the image of the image capturing device.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

For example, the whole or part of the exemplary embodiments disclosed above can be described as, but not limited to, the following supplementary notes.

(Supplementary Note 1)

A method, by a server, for dynamically identifying a user of an account for posting images, comprising:

determining, by the server, if images posted in the account of the user includes an image capturing device;

extracting, by the server, a characteristic of the image of the image capturing device when it is determined that the images in the account includes the image capturing device; and

identifying, by the server, an image capturing device of the user in response to the extraction of the characteristic of the image of the image capturing device.

(Supplementary Note 2)

The method according to note 1, further comprising:

comparing, by the server, the identified image capturing device of the user and an image capturing device of a target user; and

determining, by the server, a matching score in response to the comparison of the identified image capturing device of the user and the image capturing device of the target user.

### (Supplementary Note 3)

The method according to note 2, further comprising:
extracting, by the server, a characteristic of the images posted in the account of the user to determine a fingerprint of the image capturing device of the user,
wherein the identification of the image capturing device of the user is performed in response to the determination of the fingerprint of the image capturing device of the user.

### (Supplementary Note 4)

The method according to note 3, further comprising:
comparing, by the server, the determined fingerprint of the image capturing device and a fingerprint of the image capturing device of the target user,
wherein the matching score is determined further in response to the comparison of determined fingerprint of the image capturing device and the fingerprint of the image capturing device of the target user.

### (Supplementary Note 5)

The method according to note 4, further comprising:
determining, by the server, a content of the images posted in the account of the user.

### (Supplementary Note 6)

The method according to note 5, further comprising:
comparing, by the server, the content of the images posted in the account of the user to a content of the images posted in an account of the target user,
wherein the matching score is determined further in response to the comparison of the content of the images posted in the account of the user to the content of the images posted in the account of the target user.

### (Supplementary Note 7)

The method according to note 6, further comprising:
processing, by the server, the text posted in the account of the user.

### (Supplementary Note 8)

The method according to note 7, wherein the step of processing the text posted in the account of the user comprises:
determining, by the server, a content of the text posted in the account of the user; and comparing, by the server, the content of the text posted in the account of the user to a content of a text posted in the account of the target user,
wherein the matching score is determined further in response to the comparison of the content of the text posted in the account of the user to the content of the text posted in the account of the target user.

### (Supplementary Note 9)

The method according to note 8, further comprising:
determining, by the server, a corresponding weight to each of the (i) the comparison of the identified image capturing device of the user and the image capturing device of the target user, (ii) the comparison of determined fingerprint of the image capturing device and the fingerprint of the image capturing device of the target user, (iii) the comparison of the content of the images posted in the account of the user to the content of the images posted in the account of the target user and (iv) the comparison of the content of the text posted in the account of the user to the content of the text posted in the account of the target user,
wherein the matching score is determined in response to the determination of the corresponding weights.

### (Supplementary Note 10)

The method according to note 9, further comprising:
determining, by the server, a likelihood if the user is the target user in response to the determined matching score.

### (Supplementary Note 11)

An apparatus for dynamically identifying a user of an account for posting images, the apparatus comprising:
at least one server; and
at least one memory including computer program code;
the at least one memory and the computer program code configured to, with at least one processor, cause the apparatus at least to:
determine if images posted in the account of the user includes an image capturing device;
extract a characteristic of the image of the image capturing device when it is determined that the images in the account includes the image capturing device; and
identify an image capturing device of the user in response to the extraction of the characteristic of the image of the image capturing device.

### (Supplementary Note 12)

The apparatus according to note 11, wherein the at least one memory and the computer program code is further configured with the at least one processor to:

compare the identified image capturing device of the user and an image capturing device of a target user; and

determine a matching score in response to the comparison of the identified image capturing device of the user and the image capturing device of the target user.

### (Supplementary Note 13)

The apparatus according to note 12, wherein the at least one memory and the computer program code is further configured with the at least one processor to:
extract a characteristic of the images posted in the account of the user to determine a fingerprint of the image capturing device of the user,
wherein the identification of the image capturing device of the user is performed in response to the determination of the fingerprint of the image capturing device of the use.

### (Supplementary Note 14)

The apparatus according to note 13, wherein the at least one memory and the computer program code is further configured with the at least one processor to:
compare the determined fingerprint of the image capturing device and a fingerprint of the image capturing device of the target user;
wherein the matching score is determined further in response to the comparison of determined fingerprint of the image capturing device and a fingerprint of the image capturing device of the target user.

### (Supplementary Note 15)

The apparatus according to note 14, wherein the at least one memory and the computer program code is further configured with the at least one processor to:
determine a content of the images posted in the account of the use.

### (Supplementary Note 16)

The apparatus according to note 15, wherein the at least one memory and the computer program code is further configured with the at least one processor to:

compare the content of the images posted in the account of the user to a content of the images posted in an account of the target user,

wherein the matching score is determined further in response to the comparison of the content of the images posted in the account of the user to a content of the images posted in the account of the target user.

### (Supplementary Note 17)

The apparatus according to note 16, wherein the at least one memory and the computer program code is further configured with the at least one processor to:
processing, by the processor, the text posted in the account of the user.

### (Supplementary Note 18)

The apparatus according to any one of notes 17, wherein the at least one memory and the computer program code is further configured with the at least one processor to:
determine a content of the text posted in the account of the user; and
compare the content of the text posted in the account of the user to a content of a text posted in the account of the target user,
wherein the matching score is determined further in response to the comparison of the content of the text posted in the account of the user to the content of the text posted in the account of the target user.

### (Supplementary Note 19)

The apparatus according to any one of notes 11-18, wherein the at least one memory and the computer program code is further configured with the at least one processor to:
determine a corresponding weight to each of the (i) the comparison of the identified image capturing device of the user and the image capturing device of the target user, (ii) the comparison of determined fingerprint of the image capturing device and a fingerprint of the image capturing device of the target user, (iii) the comparison of the content of the images posted in the account of the user to the content of the images posted in the account of the target user and (iv) the comparison of the content of the text posted in the account of the user to the content of the text posted in the account of the target user,
wherein the matching score is determined in response to the determination of the corresponding weights.

### (Supplementary Note 20)

The apparatus according to any one of notes 19, wherein the at least one memory and the computer program code is further configured with the at least one processor to:
determine a likelihood if the user is the target user in response to the determined matching score.

This application is based upon and claims the benefit of priority from Singapore patent application No. 10201705921 V, filed on Jul. 19, 2017, the disclosure of which is incorporated herein in its entirety by reference.

### REFERENCE SIGNS LIST

200, 400, 600 system
202 apparatus
204 processor
206 memory
210a. 210b, 212 database
402, 404 database
406 camera source identification module
408 image/text content similarity calculation module
410 image-based mobile phone model recognition module
412 image-based object matching module
414 text-based authorship attribution module
418 matching module
502, 504 user
506 mobile phone database
602 display interface
606 communication infrastructure
607 processor
608 main memory
610 secondary memory
612 hard disk drive
617 removable storage drive
622 removable storage unit
627 communication interface
650 interface
652 audio interface
657 speaker
677 removable storage medium

1. A method, by a server, for dynamically identifying a user of an account for posting images, comprising:
determining, by the server, if images posted in the account of the user includes an image capturing device;
extracting, by the server, a characteristic of the image of the image capturing device when it is determined that the images in the account includes the image capturing device; and
identifying, by the server, an image capturing device of the user in response to the extraction of the characteristic of the image of the image capturing device.

2. The method according to claim 1, further comprising:
comparing, by the server, the identified image capturing device of the user and an image capturing device of a target user; and
determining, by the server, a matching score in response to the comparison of the identified image capturing device of the user and the image capturing device of the target user.

3. The method according to claim 2, further comprising:
extracting, by the server, a characteristic of the images posted in the account of the user to determine a fingerprint of the image capturing device of the user,
wherein the identification of the image capturing device of the user is performed in response to the determination of the fingerprint of the image capturing device of the user.

4. The method according to claim 3, further comprising:
comparing, by the server, the determined fingerprint of the image capturing device and a fingerprint of the image capturing device of the target user;
wherein the matching score is determined further in response to the comparison of determined fingerprint of the image capturing device and the fingerprint of the image capturing device of the target user.

5. The method according to claim 4, further comprising:
determining, by the server, a content of the images posted in the account of the user.

6. The method according to claim 5, further comprising:
comparing, by the server, the content of the images posted in the account of the user to a content of the images posted in an account of the target user,
wherein the matching score is determined further in response to the comparison of the content of the images posted in the account of the user to the content of the images posted in the account of the target user.

7. The method according to claim 6, further comprising:
processing, by the server, the text posted in the account of the user.

8. The method according to claim 7, wherein the step of processing the text posted in the account of the user comprises:
determining, by the server, a content of the text posted in the account of the user; and
comparing, by the server, the content of the text posted in the account of the user to a content of a text posted in the account of the target user,
wherein the matching score is determined further in response to the comparison of the content of the text posted in the account of the user to the content of the text posted in the account of the target user.

9. The method according to claim 8, further comprising:
determining, by the server, a corresponding weight to each of the (i) the comparison of the identified image capturing device of the user and the image capturing device of the target user, (ii) the comparison of determined fingerprint of the image capturing device and the fingerprint of the image capturing device of the target user, (iii) the comparison of the content of the images posted in the account of the user to the content of the images posted in the account of the target user and (iv) the comparison of the content of the text posted in the account of the user to the content of the text posted in the account of the target user,
wherein the matching score is determined in response to the determination of the corresponding weights.

10. The method according to claim 9, further comprising:
determining, by the server, a likelihood if the user is the target user in response to the determined matching score.

11. An apparatus for dynamically identifying a user of an account for posting images, the apparatus comprising:
at least one server; and
at least one memory including computer program code;
the at least one memory and the computer program code configured to, with at least one processor, cause the apparatus at least to:
determine if images posted in the account of the user includes an image capturing device;
extract a characteristic of the image of the image capturing device when it is determined that the images in the account includes the image capturing device; and
identify an image capturing device of the user in response to the extraction of the characteristic of the image of the image capturing device.

12. The apparatus according to claim 11, wherein the at least one memory and the computer program code is further configured with the at least one processor to:
compare the identified image capturing device of the user and an image capturing device of a target user; and
determine a matching score in response to the comparison of the identified image capturing device of the user and the image capturing device of the target user.

13. The apparatus according to claim 12, wherein the at least one memory and the computer program code is further configured with the at least one processor to:
extract a characteristic of the images posted in the account of the user to determine a fingerprint of the image capturing device of the user,
wherein the identification of the image capturing device of the user is performed in response to the determination of the fingerprint of the image capturing device of the use.

14. The apparatus according to claim 13, wherein the at least one memory and the computer program code is further configured with the at least one processor to:
compare the determined fingerprint of the image capturing device and a fingerprint of the image capturing device of the target user;
wherein the matching score is determined further in response to the comparison of determined fingerprint of the image capturing device and a fingerprint of the image capturing device of the target user.

15. The apparatus according to claim 14, wherein the at least one memory and the computer program code is further configured with the at least one processor to:
determine a content of the images posted in the account of the use.

16. The apparatus according to claim 15, wherein the at least one memory and the computer program code is further configured with the at least one processor to:
compare the content of the images posted in the account of the user to a content of the images posted in an account of the target user,
wherein the matching score is determined further in response to the comparison of the content of the images posted in the account of the user to a content of the images posted in the account of the target user.

17. The apparatus according to claim 16, wherein the at least one memory and the computer program code is further configured with the at least one processor to:
processing, by the processor, the text posted in the account of the user.

18. The apparatus according to claim 17, wherein the at least one memory and the computer program code is further configured with the at least one processor to:
determine a content of the text posted in the account of the user; and
compare the content of the text posted in the account of the user to a content of a text posted in the account of the target user,
wherein the matching score is determined further in response to the comparison of the content of the text posted in the account of the user to the content of the text posted in the account of the target user.

19. The apparatus according to claim 11, wherein the at least one memory and the computer program code is further configured with the at least one processor to:
determine a corresponding weight to each of the (i) the comparison of the identified image capturing device of the user and the image capturing device of the target user, (ii) the comparison of determined fingerprint of the image capturing device and a fingerprint of the image capturing device of the target user, (iii) the comparison of the content of the images posted in the account of the user to the content of the images posted in the account of the target user and (iv) the comparison of the content of the text posted in the account of the user to the content of the text posted in the account of the target user,
wherein the matching score is determined in response to the determination of the corresponding weights.

20. The apparatus according to claim 19, wherein the at least one memory and the computer program code is further configured with the at least one processor to:
determine a likelihood if the user is the target user in response to the determined matching score.
